(19) United States
(12) Patent Application Publication
(10) Pub. No.: US 2014/0019678 A1
(43) Pub. Date: Jan. 16, 2014

(54) DISK SUBSYSTEM AND METHOD FOR CONTROLLING MEMORY ACCESS

(71) Applicants: Kei Sato, Chigasaki (JP); Takeo Fujimoto, Odawara (JP)

(72) Inventors: Kei Sato, Chigasaki (JP); Takeo Fujimoto, Odawara (JP)

(73) Assignee: HITACHI, LTD., Tokyo (JP)

(21) Appl. No.: 13/576,227

(22) PCT Filed: Jul. 10, 2012
(86) PCT No.: PCT/JP12/04457

§ 371 Date: Jul. 31, 2012

(51) Int. Cl. G06F 12/16; G06F 12/00

(52) U.S. Cl. 711/105; 711/154; 711/162; 711/E12.001; 711/E12.103

(57) ABSTRACT

In a prior art disk subsystem formed by duplicating a shared memory (SM) in a DRAM (first area) and a SRAM (second area) having a higher speed than the DRAM, the data stored in the SRAM cannot be switched collectively while maintaining access to the SM, so that the access performance was deteriorated. According to the present invention, when there is a change in setting of data stored in a second area (SRAM), a data corresponding to the setting after the change is stored from a first area (DRAM) of a slave surface side SM to the second area (SRAM), and the setting of data of the second area (SRAM) is changed. After changing the setting, the slave surface side SM is changed to a master surface side SM.

### TECHNICAL FIELD

The present invention relates to a disk subsystem and a method for controlling memory access.

### BACKGROUND ART

In order to enhance the response performance for responding to a host computer, a disk subsystem is equipped with a shared memory capable of reading and writing the requested data at high speed based on a write access or a read access from the host computer.

The shared memory stores user data written into a memory device such as a storage drive, a control information for controlling the operation of the disk subsystem, and management tables. The shared memory is normally composed of a volatile DRAM (Dynamic Random Access Memory).

Patent literature 1 teaches a prior art technology related to shared memories. Patent literature 1 discloses connecting shared memories via a shared memory paths and duplicating the data within the shared memory.

Further, patent literature 2 teaches a semiconductor memory device storing data which is accessed at a high frequency in a main cache (SRAM (Static Random Access Memory)), and as for the data in which the access frequency has dropped out of the data stored in the main cache, the cached data is returned to a main memory during a clearance of a refresh operation or a transfer operation of the main memory (DRAM).

### CITATION LIST

### Patent Literature

PTL 1: Japanese Patent Application Laid-Open Publication No. 2004-185640 (U.S. Pat. No. 6,601,134)

PTL 2: Japanese Patent Application Laid-Open Publication No. 2004-355810 (U.S. Pat. No. 5,943,681)

### SUMMARY OF INVENTION

### Technical Problem

However, patent literature 1 does not teach forming the shared memory using a plurality of storage media having different performances (such as a high-speed SRAM and a DRAM having a slower speed than the SRAM).

Moreover, patent literature 2 teaches forming the semiconductor memory device via a DRAM and a SRAM, but it does not teach a process for collectively switching the data stored in the SRAM while maintaining the access to the semiconductor memory device.

Therefore, according to the inventions disclosed in patent literature 1 and patent literature 2, in a shared memory composed of a plurality of memories having different performances, when the data stored in a memory having a high access performance is changed collectively according to the change of setting of the disk subsystem, it is necessary to temporarily stop the read access and the write access, according to which the fault tolerance or the access performance is deteriorated.

### Solution to Problem

In order to solve the problems of the prior art, the present invention provides a disk subsystem in which a master surface side SM (shared memory) and a slave surface side SM are provided having a first area composed of DRAM and a second area composed of SRAM.

When there is a change in the setting of data stored in the second area (SRAM), the data corresponding to the changed setting is stored from the first area (DRAM) of the slave surface side SM to the second area (SRAM), and the slave surface side SM is changed to the master surface side SM.

### Advantageous Effects of Invention

According to the disk subsystem of the present invention, the data to be stored in the second area (SRAM) composed of SRAM can be changed collectively without influencing the process of the write access and the read access to the shared memory. Problems, configurations and effects other than those described earlier will become apparent in the following description of preferred embodiments.

### BRIEF DESCRIPTION OF DRAWINGS

FIG. 1 is a view illustrating an outline of a method for controlling memory access according to the present invention.

FIG. 2 is an overall configuration diagram of a disk system.

FIG. 3 is a hardware configuration diagram of a cache PK.

FIG. 4 is a view illustrating an allocation of the DRAM and the SRAM to a memory address space.

FIG. 5 is a view illustrating a configuration example of the SRAM allocation area table.

FIG. 6 is a view illustrating a configuration example of a window resister information table.

FIG. 7A is a flowchart illustrating a write access processing performed on the MP side.

FIG. 7B is a flowchart illustrating a read access processing performed on the MP side.

FIG. 8 is a flowchart illustrating a read/write access processing performed on the CMPK side.

FIG. 9 is a flowchart illustrating a process for changing the setting of the SRAM allocation during expansion of SM and install of program products.

FIG. 10 is a flowchart illustrating a process for changing the setting of the SRAM allocation when updating a system control program.

FIG. 11 is a flowchart illustrating a process for changing the setting of the SRAM allocation when switching the master surface side SM and the slave surface side SM.

FIG. 12 is a flowchart illustrating a process for changing the setting of the SRAM allocation without switching the master surface side SM and the slave surface side SM.

FIG. 13 is a view illustrating a data copy operation from the SRAM to the DRAM while maintaining access to the CMPK.

FIG. 14 is a flowchart illustrating a data copying process from the SRAM to the DRAM while maintaining access to the CMPK.

FIG. 15 is a view illustrating a data copy operation from the DRAM to the SRAM while maintaining access to the CMPK.

FIG. 16 is a flowchart illustrating a data copying process from the DRAM to the SRAM while maintaining access to the CMPK.

### DESCRIPTION OF EMBODIMENTS

Now, the preferred embodiments of the present invention will be described with reference to the drawings. In the following description, various information are referred to as “management table” and the like, but the various information can also be expressed by data structures other than tables. Further, the “management table” can also be referred to as “management information” to show that the information does not depend on the data structure.

The processes are sometimes described using the term “program” as the subject. The program is executed by a processor such as an MP (Micro Processor) or a CPU (Central Processing Unit) for performing determined processes. A processor can also be the subject of the processes since the processes are performed using appropriate storage resources (such as memories) and communication interface devices (such as communication ports).

The processor can also use dedicated hardware in addition to the CPU. The computer program can be installed to each computer from a program source. The program source can be provided via a program distribution server or storage media, for example.

Each element, such as each MP, can be identified via numbers, but other types of identification information such as names can be used as long as they are identifiable information. The equivalent elements are denoted with the same reference numbers in the drawings and the description of the present invention, but the present invention is not restricted to the present embodiments, and other modified examples in conformity with the idea of the present invention are included in the technical range of the present invention. The number of the components can be one or more than one unless defined otherwise.

### Outline of the Invention

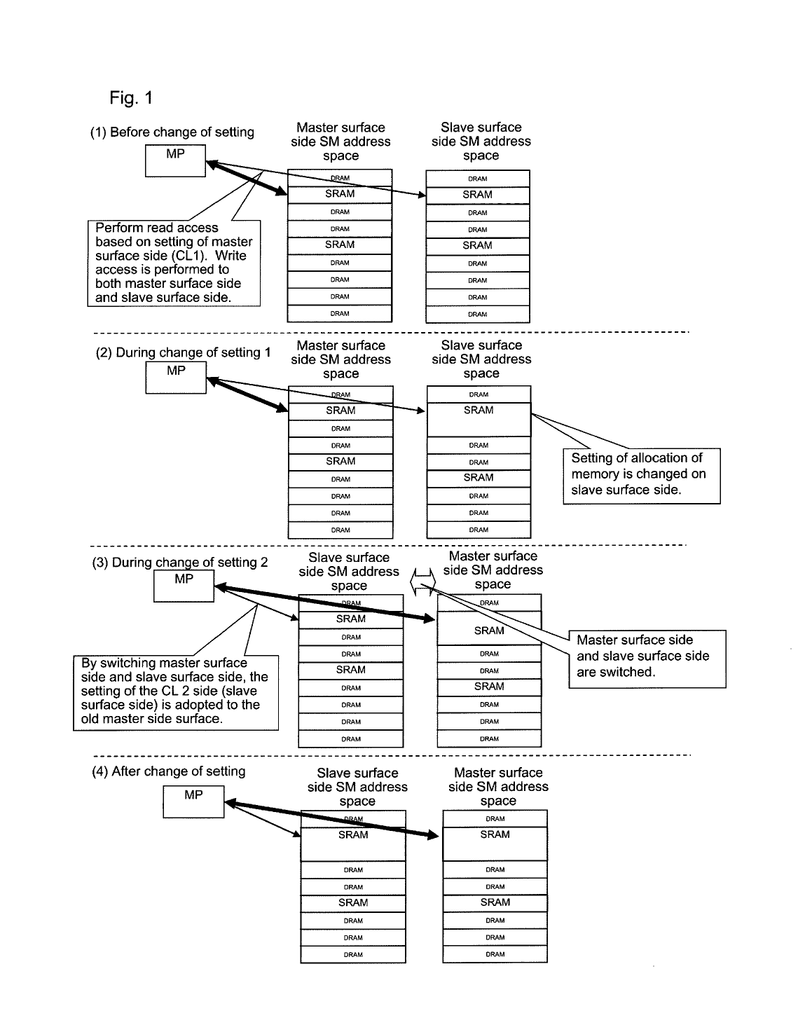

FIG. 1 is a view illustrating an outline of a method for controlling memory access according to the present invention.

The present invention provides a method for controlling a memory access capable of changing the allocation of SRAMs while maintaining a duplicated state of the SM and allowing high speed access to the SM even when a SM is expanded or when there is a change in the system control program.

According to the present disk subsystem, a memory shared and used by a MP (microprocessor) and a controller is disposed within a cache PK (hereinafter referred to as CMPK). Further, in addition to a DRAM area composed of a large-capacity DRAM memory, a high-speed small-capacity SRAM memory is mounted within the CMPK. The latter memory area is called a SRAM area.

In the disk subsystem, a section of the DRAM area is used as a cache memory (CM) used for read/write data processing of the storage disk, and other sections of the DRAM and the SRAM that can be accessed at a higher speed than the DRAM compose a shared memory (hereinafter referred to as SM).

In the SM are stored various information such as an I/O job control information, a cache control information, a system configuration information, and information related to program products (PP) which are computer programs (application programs) operating in the disk subsystem.

Each DRAM memory area has a capacity of approximately a few GB (Giga bytes) to 1 TB (Tera bytes), and the SRAM area has a capacity of approximately 1 MB to 4 MG (Mega bytes). The DRAM area and the SRAM memory area are allocated to SM address spaces which are specific memory spaces, and access is controlled via hardware disposed within the disk subsystem. In other words, control data having a high frequency access is stored in the SRAM enabling high speed access, according to which the access speed from the MP is enhanced.

Further, by performing duplication management of the SM using two CMPKs, it becomes possible to improve the access performance and enhance the fault tolerance via redundancy. The two SMs are called a master surface side SM and a slave surface side SM, and the data write request from the MP is executed to both the master surface side SM and the slave surface side SM. The data read request from the MP is executed only in the master surface side SM.

When a read access or a write access from the MP to the SM of the CMPK is received, a cache memory control unit of the CMPK refers to the information in a window resister and determines which area should be accessed, the DRAM area or the SRAM area.

Further, if expansion of SMs or change of system control program occurs to the disk subsystem, the configuration (capacity and allocation area) of the SRAM or the data stored in the SRAM are changed. Therefore, the MP changes the allocation of memory area of the slave surface side SM based on the new setting of SRAM allocation. In this case, the information on the change of the SRAM allocation is set by the MP in the window resistor of a HIT determination circuit.

At first, the outline of operation is described with reference to FIG. 1.

### (1) Before Change of Setting

The MP accesses the SM address space on the master surface side based on the setting of the master surface side (CL1), and reads data from a given memory. As for writing of data from the MP to the SM, both the master surface side SM address space and the slave surface side SM address space are accessed to write data to a given memory.

### (2) During Change of Setting 1

When SM expansion or change of system control program occurs to the disk subsystem in the state of (1), the MP changes the memory area allocation of the slave surface side SM based on the new setting of SRAM allocation. In that case, the information on the change of SRAM allocation is set from the MP to the window resister of the HIT determination circuit.

### (3) During Change of Setting 2

After the change of memory area allocation in the slave surface side SM is completed in (2), the master surface side SM and the slave surface side SM are switched. Through this switching, the master surface side setting is changed from “CL1” to “CL2”, according to which the old slave surface becomes the new master surface and the old master surface becomes the new slave surface. The MP executes the change of allocation of memory area similarly in the SM that has newly become the slave surface side.

### (4) After Change of Setting

Based on the operation to change the memory area allocation in the master surface side SM and the slave surface side SM in (2) and (3), the memory area allocation of both SMs can be changed to the same while maintaining the duplicate status of SM and the high speed access to the SM. The state after the change of settings is (4).

Further, it is possible to change the allocation of memory areas on the master surface side and the allocation of memory areas on the slave surface side without executing switching of the master surface side and the slave surface side as described in (3).

Furthermore, it is possible to execute the change of allocation of memory areas on the master surface side and change of allocation of memory areas on the slave surface side in parallel in a memory controller within the CMPK without executing switching of the master surface side and the slave surface side as described in (3).

As described, the present disk subsystem is capable of changing the allocation of SRAM while maintaining the duplicated state of the SM and the high speed access to the SM. The detailed processes and operations thereof will be described later.

### System Configuration

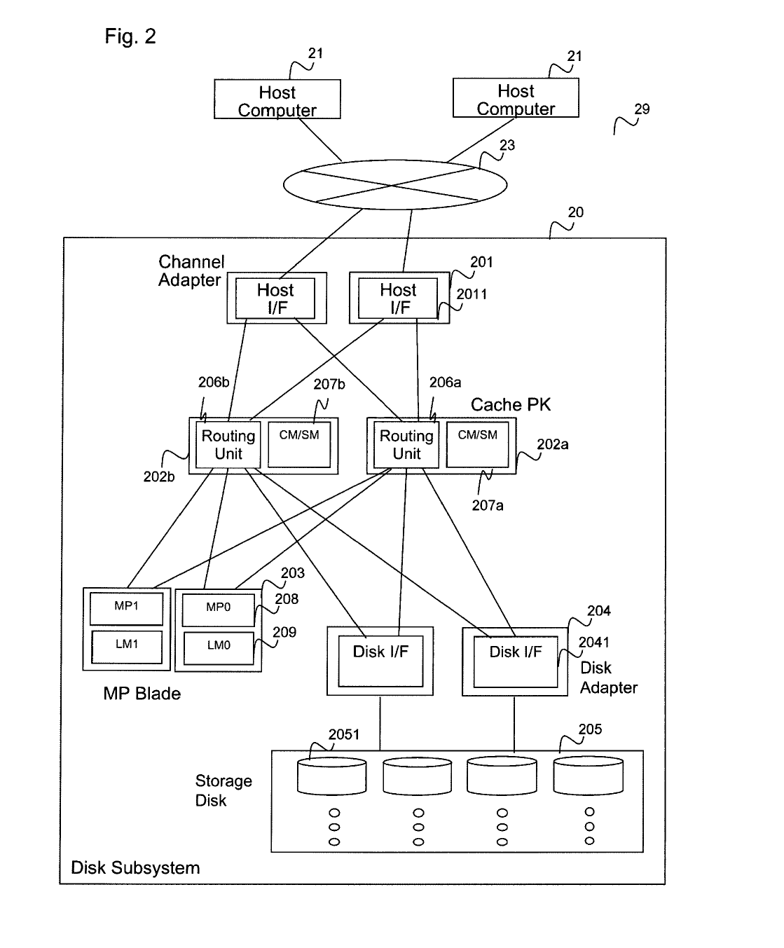

FIG. 2 is an overall configuration diagram of a disk system.

The disk system 29 is composed of a disk subsystem 20 and a host computer (hereinafter referred to as host) 21. One or more hosts 21 are coupled via a network such as a SAN (Storage Area Network) 23 and through a host I/F 2011 of a channel adapter 201 to the disk subsystem 20.

The host 21 reads data from the disk subsystem 20 or writes data into the disk subsystem 20 through the host I/F 2011 of the channel adapter 201.

The disk subsystem 20 is composed of a plurality of channel adapters 201, a plurality of cache PKs (CMPKs) 202, a plurality of MP blades 203, a plurality of disk adapters 204 and a storage disk unit 205, and adopts a redundant configuration.

The cache PK (CMPK) 202 is composed of a routing unit 206 which is a cache control unit, and a CM/SM (cache memory/shared memory) 207 which is a memory unit. Further, the CMPK 202a and the CMPK 202b are collectively called CMPK 202. The routing unit 206 and the CM/SM 207 are called similarly.

The CMPK 202 is a memory device having a volatile memory such as a DRAM or a SRAM and/or a nonvolatile memory such as a flash memory. The CMPK 202 has a storage area for temporarily storing the read data from the storage disks or the write data to the storage disks (hereinafter referred to as cache memory area, or in short, CM).

The CMPK 202 has a storage area (hereinafter referred to as shared memory area, or in short, SM) storing various control information, PP (program products) and management tables.

One example of PP is a remote copy software for copying the same data from the disk subsystem to an external disk subsystem disposed at a sufficiently remote location. In addition, the disk subsystem includes a software called a local copy software for creating a copy data within the system.

The CMPK 202 is connected to a channel adapter 201, an MP blade 203 and a disk adapter 204.

A routing unit 206 is for controlling the sorting of packets entered to the CMPK 202 from the channel adapter 201 or the MP blade 203 or the disk adapter 204, which is composed for example of a crossbar switch.

If the CMPK 202a is set as the master surface side CMPK, the CMPK 202b becomes the slave surface side CMPK. Similarly, the SM of the master surface side CMPK 202a becomes the master surface side SM, and the SM of the slave surface side CMPK 202b becomes the slave surface side SM. Moreover, after performing the switching operation of the master surface and the slave surface mentioned later, the CMPK 202a and the SM therein becomes the slave surface side, and the CMPK 202b and the SM therein becomes the master surface side.

The MP blade 203 has a plurality of MPs 208 and a plurality of local memories (hereinafter referred to as LM) 209. The MP 208 sends a data transfer request to the host I/F 2011 and the disk I/F 2041. In addition, in order to realize high speed access to the I/O control information and the disk subsystem control information, each MP 208 is connected respectively to a single LM 209. Moreover, each MP 208 shares the SM of the CMPK 202, and stores the common control information in the SM.

The disk adapter 204 has a disk I/F controller 2041 built therein, and the disk I/F controller 2041 controls the data access between the CMPK 202 and the storage disk unit 205.

The storage disk unit 205 includes, as storage drives, although not shown, a SAS interface type SSD, a SAS type HDD and a SATA type HDD. Further, the storage drive is not restricted to the one described earlier, but can be a FC (Fiber Channel) type HDD or a tape. The storage disk unit 205 is connected to the disk I/F controllers 2041 via a communication line such as a fiber channel cable, and constitutes a RAID group via a plurality of storage drives.

### Hardware Configuration of Cache PK

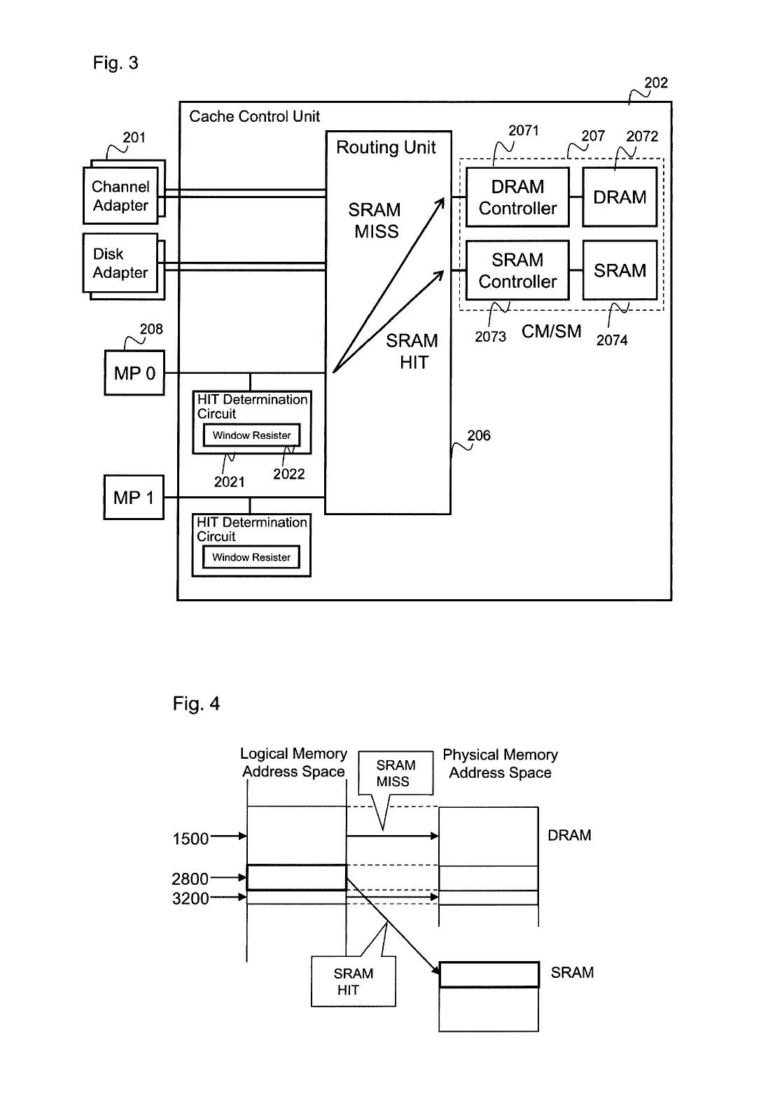

FIG. 3 is a hardware configuration diagram of a cache PK.

The CMPK 202 includes a cache control unit having a routing unit 206 and a HIT determination circuit 2021 and a SM/CM 207 as the memory unit.

The HIT determination circuit 2021 includes a window resister 2022. The window resister 2022 stores a SRAM allocation area table and a window resister information table mentioned later.

The SM/CM 207 is composed of a plurality of DRAMs 2072, a DRAM controller 2071 for controlling the DRAMs 2072, a plurality of SRAMs 2074 and a SRAM controller 2073 for controlling the SRAMs.

The DRAM controller 2071 is connected to a DRAM 2072, and controls the writing of data to the DRAM 2072 and the reading of data from the DRAM 2072.

The SRAM controller 2073 is connected to the SRAM 2074, and controls the writing of data to the SRAM 2074 and the reading of data from the SRAM 2074. The DRAM controller 2071 and the SRAM controller 2073 can be collectively referred to as a memory controller.

The DRAM 2072 is a volatile memory for storing the user data. By supplying power from the exterior to the DRAM 2072 to set the mode thereof to a self-refresh mode or the like, the DRAM can be set to a nonvolatile state capable of retaining data.

The SRAM 2074 is a volatile memory for storing the control information for controlling the operation of the disk subsystem 20. In the present embodiment, the SRAM 2074 is mapped within the memory space of the DRAM 2072. By using a SRAM of the type having a battery disposed therein, the data in the SRAM 2074 can be retained even if power supply from the exterior is stopped.

The HIT determination circuit 2021 compares the logical memory address from the MP 208 and the logical memory address set in the window resistor information table of the window resister 2022, and determines whether the access from the MP 208 relates to the DRAM 2072 or to the SRAM 2074.

If the logical memory address from the MP 208 does not correspond to the logical memory address in the window resister information table, the HIT determination circuit 2021 determines that the condition is a “SRAM MISS”, and orders the DRAM controller 2071 to access the DRAM 2072.

If the logical memory address from the MP 208 corresponds to the logical memory address in the window resister information table, the HIT determination circuit 2021 determines that the condition is a “SRAM HIT”, and orders the SRAM controller 2073 to access the SRAM 2074. This determination operation is called a HIT/MISS determination.

The HIT determination circuit 2021 is provided for each MP 208 (MP0/MP1), and executes the aforementioned HIT/MISS determination for each MP. Thereby, for example, even if access from the MP0 and MP1 to the CMPK 202 occurs simultaneously, the HIT/MISS determination can be executed in parallel for each MP, so that a high speed HIT/MISS determination is enabled. The actual operation of the HIT/MISS determination will be described with reference to FIG. 4.

### Memory Address Space

FIG. 4 is a view illustrating the allocation of the DRAM and the SRAM to the memory address space.

Although not illustrated, the DRAM is allocated from “0000” to “2000”, the SRAM is allocated from “2000” to “3000”, and the DRAM is allocated to “3000” and thereafter of the logical memory address space, and based thereon, the window resistor information table of the window resister 2022 is set.

If the logical memory address to be accessed from the MP 208 to the SM is “1500” and “3200”, the HIT determination circuit 2021 determines that the access is an access to the DRAM instead of an access to the SRAM, and determines that the access is a “SRAM MISS”. Then, the routing unit 206 converts the logical memory address to an address of the physical memory address space allocated to the DRAM 2072. The DRAM controller 2071 accesses the DRAM 2072 based on the converted physical memory address.

Further, if the logical memory address to be accessed from the MP 208 is “2800”, the HIT determination circuit 2021 determines that the access is an access to the SRAM and that the access is a “SRAM HIT”. Then, the routing unit 206 converts the logical memory address to an address (physical memory address) of the physical memory address space allocated to the SRAM 2074. The SRAM controller 2073 accesses the SRAM 2074 via the converted physical memory address.

As described, the routing unit 206 sorts the access from the MP 208 to the DRAM 2072 or the SRAM 2074 based on the contents of setting in the window resister information table.

### SRAM Allocation Area Table

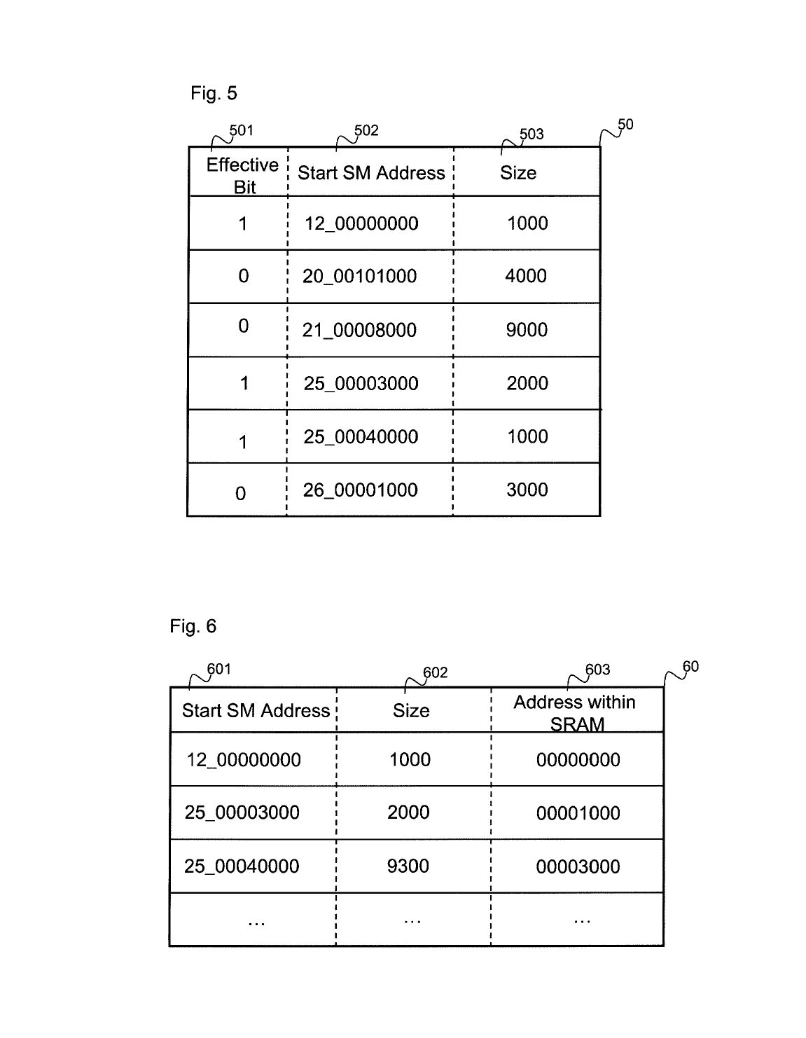

FIG. 5 is a view illustrating a configuration example of the SRAM allocation area table.

The SRAM allocation area table 50 shows a list of the control information area to be set to the SRAM retained in the MP. The SRAM allocation area table 50 is stored in the SM of CM/SM 207 or the window resistor 2022, which is arbitrarily referred to by the MP 208 or the memory controller of the DRAM controller 2071 or the SRAM controller 2073, and used in the processes such as the SRAM allocation change process described later.

The information stored in each row of the SRAM allocation area table 50 corresponds to the control information frequently accessed by IO or aforementioned PP.

The above-described control information can be a “cache control counter” for managing whether the data in a CM area of the CM/SM 207 is dirty or not, a “remote copy control SEQ #” which is a sequential number for ensuring the copy order in a remote copy which is one of the program products, and a “secondary VOL controlling bit of local copy” which is a control information of a local copy which is also one of the program products mentioned earlier.

An SRAM allocation area table 50 is composed of an effective bit 501, a start SM address 502 showing the storage location of control information, and size 503.

The effective bit 501 is a bit indicating whether the settings of the start SM logical address (hereinafter referred to as start SM address) 502 and the size 503 are effective in the current configuration. The bit is switched between effective and not effective when starting the specification of the present area (when changing the SM capacity or when installing the PP or the like). Incidentally, “1” indicates effective, and “0” indicates not effective.

The start SM address 502 represents a start of the SM address for starting the SRAM allocation. Further, the size 503 indicates a size of the SM area allocated to the SRAM. For example, the first entry stores the information that the SRAM is allocated to an area in which the start SM address starts at “12_{—}00000000” and the size is “1000”, and that the information is effective. The second entry also has a SRAM allocation information stored therein, but since the effective bit 501 related to the information is set to “0”, it can be recognized that the information is not effective.

Based on the SRAM allocation area table 50, it is possible to set the storage location in the SRAM area of the control information that is frequently accessed via a given IO or the PP described earlier.

### Window Resister Information Table

FIG. 6 is a view illustrating a configuration example of a window resister information table. A window resister information table is a table for sorting the access from the MP to the DRAM or to the SRAM.

The window resister information table 60 is a table stored within the window resister 2022 of the cache PK 202. Based on the table information of the window resister information table 60, the routing unit 206 determines the HIT/MISS of access to the SRAM, and changes the memory access from the MP to SRAM access or DRAM access. The window resister information table 60 is arbitrarily referred to from the MP 208 or the memory controller.

The window resister information table 60 is composed of a start SM address 601, a size 602, and a physical address within SRAM (hereinafter referred to as address within SRAM) 603.

The start SM address 601 is an SM address for starting the SRAM allocation. The size 602 is the size of the SM area allocated to the SRAM. The address within SRAM 603 shows the physical address of the SRAM being the allocation destination.

The MP or the memory controller determines whether there is a change in the setting of the SRAM area by comparing the SRAM allocation area table 50 and the window resister information table 60.

That is, in the SRAM allocation area table 50, the size 503 of the area where the start SM address 502 is “12_{—}00000000” and the effective bit 501 is “1” is “1000”, which means that the SRAM is allocated to the area starting from the start SM address 502 of “12_{—}00000000” and with a size of “1000”.

The size 503 of the area where the start SM address 502 is “25_{—}00003000” is “2000”, which means that the SRAM is allocated to the area starting from the start SM address 502 of “25_{—}00003000” and with a size of “2000”.

The start SM address 601 and size 602 in the window resister information table 60 corresponding to the start SM address 602 and size 602 of the SRAM allocation area table 50 store the same values. This means that either the setting of the SRAM area is not changed, or the change in the settings is completed within the disk subsystem including the window resister information table 60.

Further, the size 503 of the area where the start SM address 502 is “25_{—}00040000” in the SRAM allocation area table 50 is “1000”. On the other hand, the area where the start SM address 601 is “25_{—}00040000” in the corresponding window resister information table 60 has a size 602 of “9300”, which differs from the value stored in the SRAM allocation area table 50. As described, when there is a difference in the compared setting information of tables, the MP 208 can determine that the change of SRAM area has occurred.

In the window resister information table 60, the access from the MP is sorted to the DRAM or the SRAM. Further, whether the SRAM allocation is changed or not can be determined by the MP or the memory controller comparing the contents of the window resister information table 60 to the contents of the SRAM allocation area table 50.

### MP Read/Write Access Processing

### Write Access on MP Side

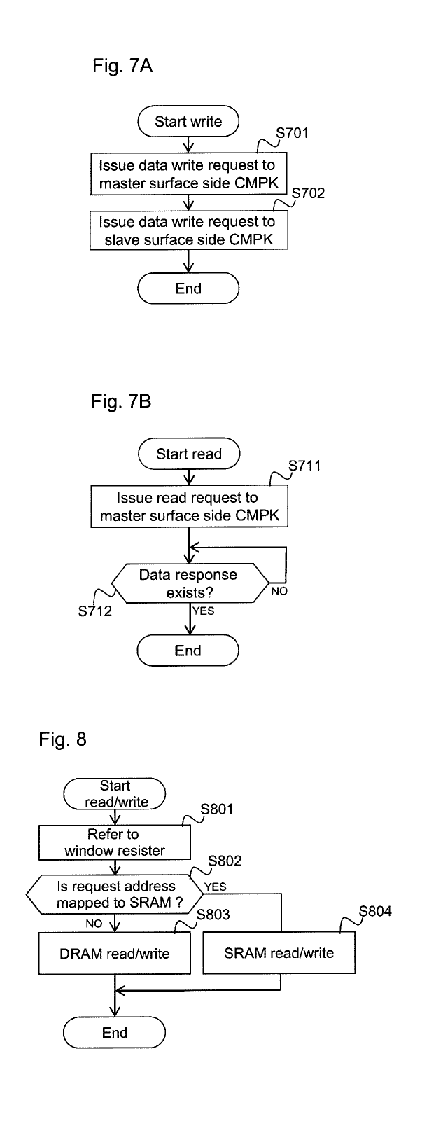

FIG. 7A is a flowchart illustrating a write access processing performed on the MP side. Next, the write access processing performed to the MP side when two sides are composed in the SM (master surface/slave surface) will be described.

In S701, the MP 208 issues data write to the master surface side CMPK, and writes data into the memory of the master surface side CMPK.

In S702, the MP 208 issues data write to the slave surface side CMPK, and writes data into the memory of the slave surface side CMPK. After completing writing of data, the MP 208 ends the write access processing.

According to the above-illustrated processing of S701 and S702, the consistency of data in the master surface side CMPK and data in the slave surface side CMPK can be maintained.

### Read Access on MP Side

FIG. 7B is a flowchart illustrating the read access processing performed on the MP side. Next, the read access processing on the MP side when two side configuration of SM is adopted will be described.

In S711, the MP 208 issues a read request only to the master surface side CMPK. The master surface side CMPK having received the read request sends the data corresponding to the read request to the MP 208.

In S712, the MP 208 determines whether a response to reading of data is received from the master surface side CMPK. If there is no response regarding reading of data (S712: No), the MP 208 repeats the process of S712 until the response regarding reading of data from the master surface side CMPK is received.

When response of data from the master surface side CMPK is received (S712: Yes), the MP 208 ends the read access processing.

As described, the read access from the MP 208 to the SM is executed only in the master surface side SM, so that it is not affected by the write access processing or the operation to change the SRAM allocation performed in the slave surface side SM. Further, the present operation will not affect the processes and operations performed in the slave surface side SM.

### CMPK Side

FIG. 8 is a flowchart illustrating the read/write access processing performed on the CMPK side.

At first, it is assumed that a read access or a write access from the MP 208 to the CMPK 202 has occurred.

In CMPK 202 having received the access request from the MP 208, the HIT determination circuit 2021 which is a cache control unit refers to the window resister information table 60 within the window resister 2022, and acquires the start SM address 601 and the size 602 (S801).

In S802, the HIT determination circuit 2021 determines whether the access address from the MP 208 is mapped in the SRAM or not. Actually, the HIT determination circuit 2021 determines whether the access address exists in the address range computed by the start SM address 601 and the size 602 acquired in S801.

If the access address is included the computed address range (S802: Yes), the HIT determination circuit 2021 determines that the access address is mapped to the SRAM, and executes S804.

If the access address is not included in the computed address range (S802: No), the HIT determination circuit 2021 determines that the access address is not mapped to the SRAM, and executes S803.

In S803, the HIT determination circuit 2021 converts the access address (SM address) to the DRAM address (physical address). The HIT determination circuit 2021 transmits via the routing unit 206 the access request and the DRAM address to the DRAM controller 2071. The DRAM controller 2071 having received the access request either reads the data in the area corresponding to the DRAM address or writes data into the corresponding area.

In S804, the access address (SM address) is converted to a SRAM address (physical address) and stored in the address within SRAM 603 of the window resister information table 60. Actually, if the start SM address 601 is “12_{—}00000100”, the SRAM address is converted to “0100”, and if the start SM address 601 is “25_{—}00004000”, the SRAM address is converted to “2000”. In other words, the difference between the access address and the start SM address 601 is added to the address within SRAM 603.

The HIT determination circuit 2021 sends via the routing unit 206 the access request and the converted SRAM address to the SRAM controller 2073. The SRAM controller 2073 having received the access request either reads the data in the area corresponding to the SRAM address or writes data into the corresponding area.

As described, when a read access or a write access from the MP to the SM of the CMPK is received, the cache memory control unit of the CMPK 202 refers to the information within the window resister 2022, and performs control to access either the DRAM area or the SRAM area.

### Change of Setting of SRAM Allocation 1

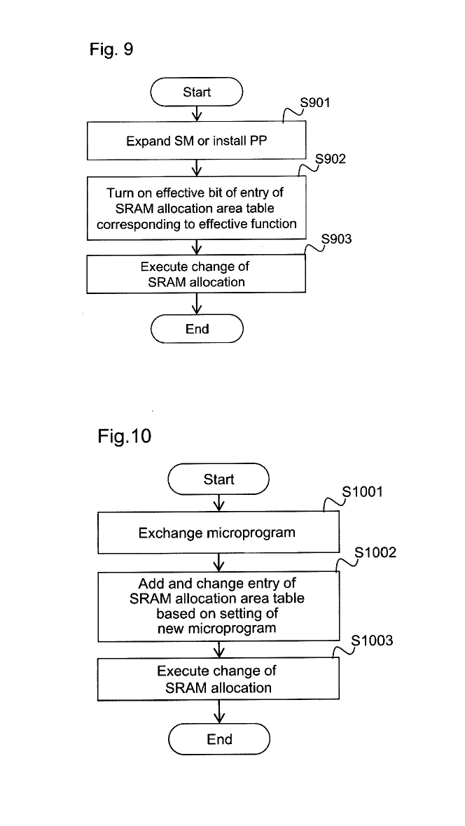

FIG. 9 is a flowchart illustrating the process for changing the setting of the SRAM allocation when SM expansion and install of program products are performed.

In a shared memory composed of a plurality of memories having different performances, there is a drawback in that read accesses and write accesses must be temporarily suspended in order to collectively change the data stored in a memory having a high access performance in response to the change of settings of the disk subsystem. Change of settings of the disk subsystem is caused for example by the expansion of capacity of DRAM and SRAM constituting the SM, the install of PP, and the update of the system control program.

There is another drawback in that when the data to be stored in the memory having a high performance is determined considering the access frequency or the like after the PP such as the aforementioned local copy function or the remote copy function is installed and operation is started, the access performance from the start of the operation to the data determination processing is deteriorated.

Therefore, according to the present invention, the above-described problems are solved by performing the change of settings of the SRAM allocation illustrated in FIG. 9 and thereafter, the switching of the master surface and the slave surface in the SM, and the copy operation among memories.

In S901, the system administrator executes install of the SM expansion or PP with respect to the disk subsystem 20. The MP 208 of the disk subsystem 20 executes S902 when it detects that the SM expansion or the install of PP by the system engineer is completed.

In S902, the MP 208 adds the address information and the size information related to the SRAM area storing a data having a high access frequency to the SRAM allocation area table 50 and changes the same via a function that has become effective by installing the PP. Then, the MP 208 updates the effective bit 501 of the relevant entry to ON, in other words, updates the set value of the effective bit 501 from “0” to “1”. Further, the MP 208 changes the SRAM allocation area table 50 via the address information and the size information of the SRAM area that has become effective via SM expansion.

Incidentally, data having a high access frequency is the control information frequently accessed via the aforementioned IO and aforementioned PP, which are data such as a “cache control counter” for managing dirty data, or a “remote copy control SEQ #” for ensuring the copying order.

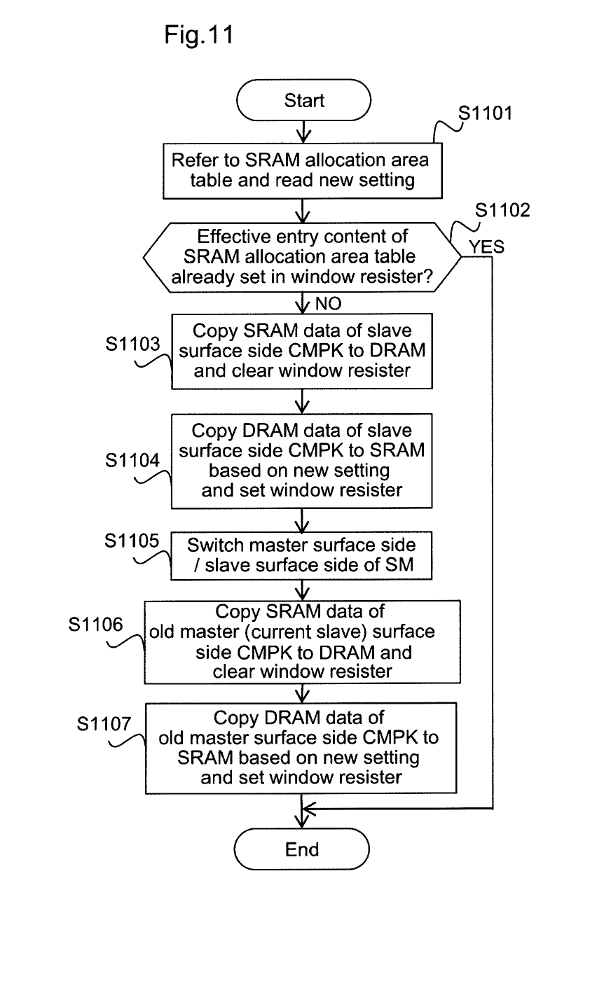

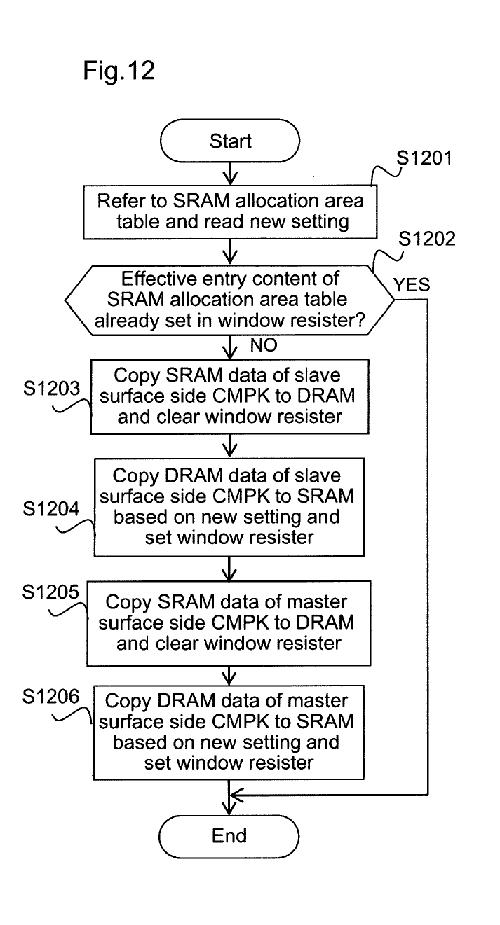

In S903, the MP 208 and the memory controller (DRAM controller 2071, SRAM controller 2073) executes the change of allocation of SRAM shown in FIGS. 11 and 12.

### Change of Setting of SRAM Allocation 2

FIG. 10 is a flowchart illustrating the process of changing the setting of the SRAM allocation when updating the system control program.

In S1001, the system administrator executes the update of the microprogram which is a system control program with respect to the disk subsystem 20. The MP 208 of the disk subsystem 20 executes S902 when completion of update of the microprogram is detected.

In S1002, the MP 208 adds an entry corresponding to the data of the system control information having a high access frequency to the SRAM allocation area table 50 and changes the table 50 based on the setting of the new microprogram.

In S1003, the MP 208 and the memory controller executes the change of SRAM allocation illustrated in FIG. 11 and FIG. 12.

### Change of SRAM Allocation 1 (Execution of Switching of Master Surface/Slave Surface Side SM)

FIG. 11 is a flowchart of a process for changing the setting of the SRAM allocation by switching the master surface side SM and the slave surface side SM. The present process executes the change of setting of the SRAM allocation while maintaining access to the SM in the CMPK 202. In the following description, the DRAM controller 2071 and the SRAM controller 2073 may be collectively called a memory controller.

In S1101, the MP 208 refers to the SRAM allocation area table 50, and reads an entry of a new setting in which the effective bit 501 is “1”. The read entry is set as an effective entry.

In S1102, the MP 208 determines whether the contents of the effective entry in the SRAM allocation area table 50 is already set in the window resister 2022 or not. Whether the information is set or not is determined by whether the effective contents of entry in the SRAM allocation area table 50 coincide with the contents of the window resister information table 60.

In other words, the MP 208 determines that the setting is completed when the contents coincide, but if they do not coincide, the MP 208 determines that the content of the effective entry of the SRAM allocation area table 50 is not reflected in the window resister information table 60. As described, the MP 208 is capable of determining whether the change of settings is necessary or not based on the difference between the contents of the SRAM allocation area table 50 and the contents of the window resister information table 60.

If information is already set in the window resister information table 60 (S1102: Yes), the MP 208 determines that the change of the SRAM allocation is completed, and ends the processing of the change of settings of the SRAM allocation.

If the setting is not completed (S1102: No), the MP 208 determines that the change of the SRAM allocation is not completed, and executes S1103.

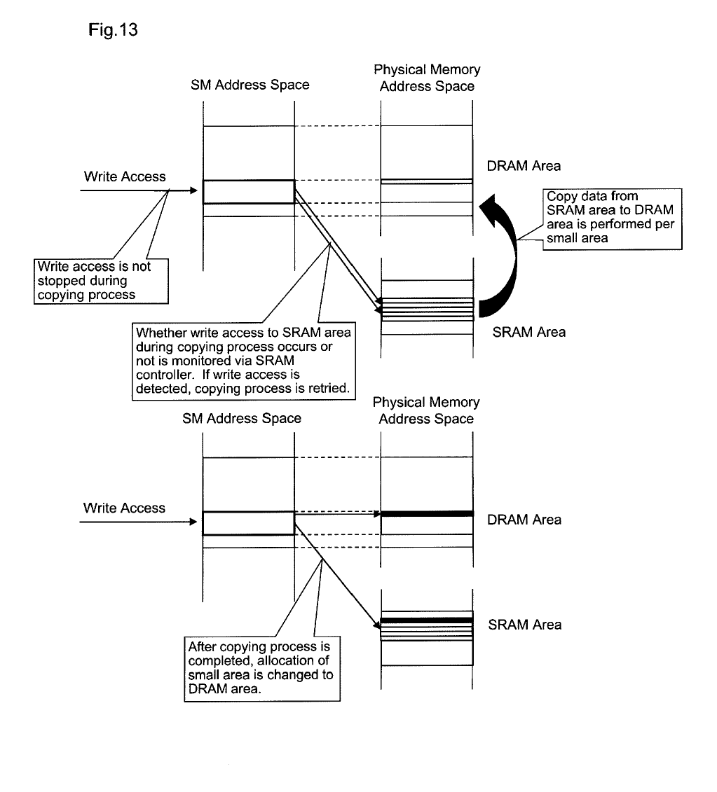

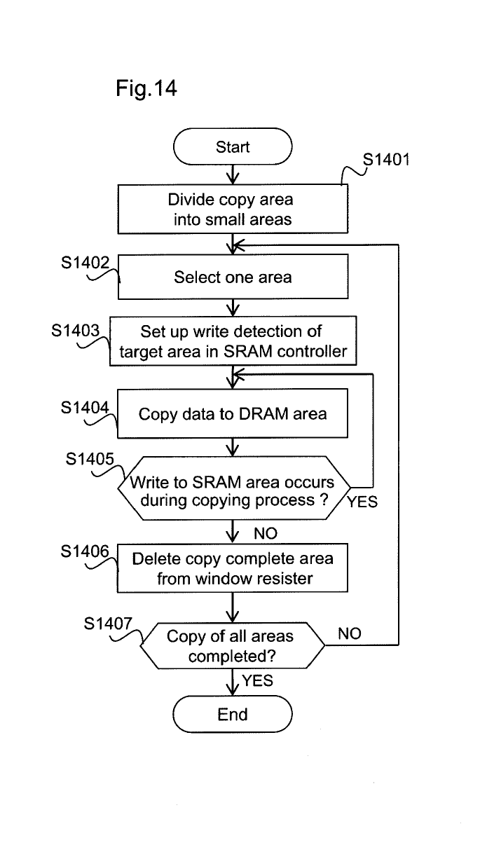

In S1103, the MP 208 requests the memory controller to perform a process to copy the SRAM data in the slave surface side CMPK to the DRAM (FIGS. 13 and 14).

After completing the copying process, the MP 208 clears the window resister information table 60 of the slave surface side CMPK.

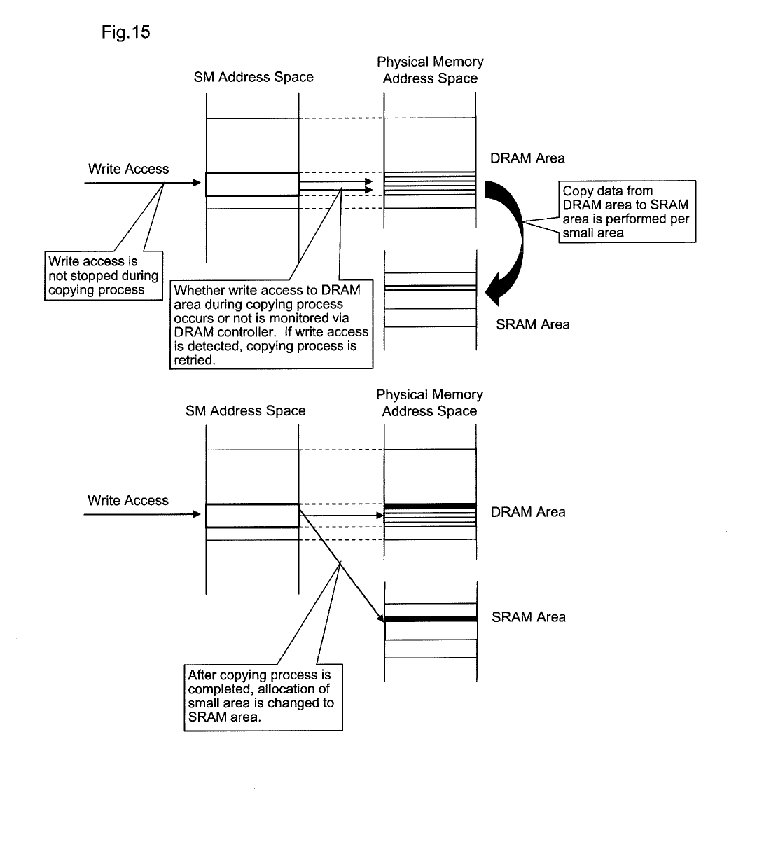

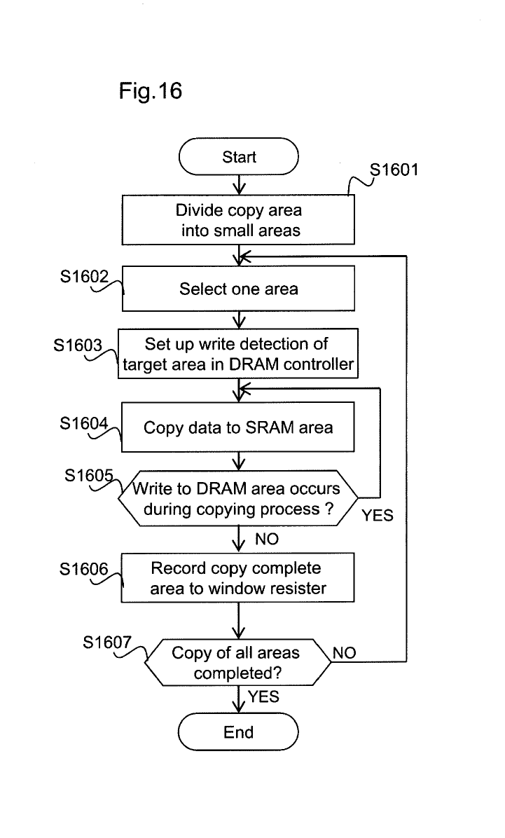

In S1104, the MP 208 requests the memory controller to perform a process to copy the DRAM data in the slave surface side CMPK to the SRAM based on the new setting of the SRAM allocation (FIGS. 15 and 16).

After completing the copying process via the memory controller, the MP 208 sets the effective entry contents of the SRAM allocation area table 50 and the physical address information within the SRAM to the window resister information table 60.

In S1105, the MP 208 switches the master surface and the slave surface of the SM. The switching of the master surface and the slave surface of the SM is performed by setting the master surface information in the master surface management table (not shown).

In S1106, the MP 208 requests the memory controller to perform a process to copy the SRAM data in the old master surface (current slave surface) side CMPK to the DRAM (FIGS. 13 and 14).

After completing the copying process, the MP 208 clears the content of the window resister information table 60 of the old master surface (current slave surface) side CMPK.

In S1107, the MP 208 orders the memory controller to copy the DRAM data in the old master surface (current slave surface) side CMPK to the SRAM based on the new setting of the SRAM allocation (FIGS. 15 and 16).

After completing the copying process, the MP 208 sets the effective entry contents in the SRAM allocation area table 50 to the window resister information table 60.

As described, the present embodiment is effective in that the change of setting of data stored in the SRAM (change of setting of SRAM area) can be performed collectively without influencing the read access processing and the write access processing of the SM.

Especially, since the read access is performed only to the master surface side SM, by performing the change of setting of the SRAM area only on the slave surface side by switching the master surface and the slave surface, the process will not affect the read access performance.

### Change of SRAM Allocation 1 (No Execution of Switching of the Master Surface/Slave Surface Side SM)

FIG. 12 is a flowchart illustrating the process for changing the setting of the SRAM allocation without switching the master surface side SM and the slave surface side SM. Similar to FIG. 11, the present processing also changes the setting of the SRAM allocation while continuing the access to the SM in the CMPK 202.

The processes from S1201 to S1204 of FIG. 12 and the processes from S1101 to S1104 of FIG. 11 are the same. Further, the processes of S1205 and S1206 of FIG. 12 are the same as the processes of S1106 and S1107 of FIG. 11. The difference between FIG. 12 and FIG. 11 is that in the process of FIG. 12, there is no switching process of the master surface side SM and the slave surface side SM performed in S1105 of FIG. 11.

The deterioration of access performance by the temporary cancelling of the SRAM allocation during change of setting influences the master surface side, and the read access performance to the SM is somewhat deteriorated, but it is effective in that the change of setting of the SRAM allocation is enabled while the duplicated state is maintained and the change process can be simplified.

The process of changing the SRAM allocation on the master surface side in S1203 and S1204 and the process of changing the SRAM allocation on the slave surface side in S1205 and S1206 can be executed in parallel in the respective memory controllers in the CMPKs. According to the parallel processing, it becomes possible to end the process of changing the SRAM allocation in a short time without influencing the process of the MP.

According to the process of FIG. 11 and FIG. 12, the disk subsystem 20 can copy data from the DRAM to the SRAM while continuing the access to the CMPK 202 without stopping the access and while maintaining the duplicated status of the SM, and the data stored in the memory having a high access performance can be collectively changed according to the change of settings of the disk subsystem.

Further, even when a PP such as a local copy function is newly installed and operation is started, the deterioration of access performance that has occurred during the time before determining the data to be stored in a memory having a high performance considering the access frequency of the data and the like can be prevented.

Further, it is possible to select the data in which the frequency of use via the PP is possibly high, and to instantly change the setting of the SRAM area for collectively storing the selected data in a high speed SRAM area, so that the access performance to data having a high frequency of use can be improved.

### Copying of Data from SRAM to DRAM

FIG. 13 is a view illustrating the data copy operation from the SRAM to the DRAM when access to the CMPK is continued. FIG. 14 is a flowchart illustrating the data copy process from the SRAM to the DRAM while access to the CMPK is maintained.

### Outline of Data Copy Operation

The outline of the data copy operation from the SRAM to the DRAM in FIGS. 11 and 12 will be illustrated in FIG. 13. The present operation performs data copy from the SRAM to the DRAM in order to save the data stored only in the SRAM to the DRAM prior to changing the SRAM allocation.

### (1) Continuation of Access During Copying Process

Even during operation of the present data copy process, the write access and the read access from the MP 208 to the SM will not be stopped.

(2) Division of Copy Area into Small Areas

The MP 208 divides the SRAM area mapped to a given area within the SM address area into given sizes. The areas divided into given sizes are called small areas.

### (3) Monitoring of Write Access to SRAM Area During Copying Process

Whether write access occurs to the SRAM area or not during copying process is monitored via the SRAM controller 2073. When write access is detected during copying process, the memory controller retries the copying process.

(4) Copying of Data of Each Small Area from SRAM Area to DRAM Area

Execute data copy of small areas of SRAM to small areas of DRAM via the DRAM controller 2071 and the SRAM controller 2073.

### (5) Change Allocation to DRAM Area of Copy Complete Area

The MP 208 updates the window resister information table 60 so as to change the allocation of the area having completed the copying process from the SRAM area to the DRAM area. After update, the access from the MP 208 regarding the area where data copy is completed is executed to the DRAM.

### Data Copying Process

The actual process for realizing the above operation will be described with reference to FIG. 14. The process of FIG. 14 is started when the MP 208 detects completion of the SM expansion, install of a new PP, or update of the microprogram.

In S1401, the MP 208 divides the SRAM area mapped to a given area within the SM address space into given sizes. For example, if the size of the SRAM area mapped to the SM address space is 1 MB, the MP 208 divides the SRAM area into 128 parts and forms small areas each having an 8-KB capacity.

In S1402, the MP 208 selects a single small area (8 KB).

In S1403, the MP 208 sets up the detection of write access of the copy target small area to the SRAM controller 2073.

In S1404, the MP 208 orders the memory controller to copy data from the selected small area of the SRAM to the DRAM area. The memory controller having received the order copies the data in the small area to the DRAM area, that is, copies the data in the SRAM 2074 to the DRAM 2072. The copy operation corresponding to the data capacity (8 KB) of the small area is executed by the memory controller.

In S1405, the MP 208 determines whether write access has occurred to the small area of the copy-target SRAM during copying process based on the write access detection information from the SRAM controller 2073.

If write access has occurred (S1405: Yes), the MP 208 orders the memory controller to copy data from the small area to the DRAM area in S1404, and re-executes data copy.

If write access has not occurred (S1405: No), the MP 208 deletes the copy complete area from the window resister information table 60.

Actually, the MP 208 adds the address corresponding to the 8 KB of data having been copied to the entry of the start SM address 601 corresponding to the copy target area in the window resister information table 60, and subtracts 8 KB worth of capacity from the entry of the size 602.

In S1407, it is determined whether data copy to all areas (1 MB worth) of the copy target has been completed or not.

If data copy is not completed (S1407: No), the MP 208 executes the processes of S1402 and thereafter.

If data copy is completed (S1407: Yes), the MP 208 ends the data copying process from the SRAM 2074 to the DRAM 2072 while access to the CMPK 202 is continued. In FIGS. 13 and 14, the MP and the memory controller cooperate to execute the data copy operation, but it is possible for the memory controller alone to execute the data copy operation based on the order from the MP.

According to the above-described process, data can be copied from the SRAM 2074 to the DRAM 2072 while continuing accesses from the CMPK 202 to the SM and maintaining a duplicated status in the SM.

### Copying of Data from DRAM to SRAM

FIG. 15 is a view illustrating a data copy operation from the DRAM to the SRAM when access to the CMPK is continued. FIG. 16 is a flowchart illustrating the data copy process from the DRAM to the SRAM while access to the CMPK is maintained.

### Outline of Data Copy Operation

The outline of the data copy operation from the DRAM to the SRAM in FIG. 11 or FIG. 12 mentioned earlier will be described with reference to FIG. 15. This operation enables to improve the access performance to the memory by copying the data having a high access frequency in the DRAM to the SRAM.

### (1) Continue Access During Copying Process

Similar to the data copy operation in FIG. 13, the write access and the read access to the SM from the MP 208 is not stopped even during the present copy operation.

(2) Division of Copy Area into Small Areas

The MP 208 divides the DRAM area mapped to a given area of the SM address space to given sizes.

(3) Monitoring of Write Access with Respect to DRAM Area During Copying Process

During copying process, whether write access to the DRAM area exists or not is monitored by the DRAM controller 2071. When write access is detected during copying process, the memory controller retries the copying process.

(4) Copying of Data in Small Areas from DRAM Area to SRAM Area

The memory controller executes copying of data from small areas of the DRAM area to the SRAM area.

### (5) Change of Allocation of Copy Complete Area to SRAM Area

The MP 208 updates the window resister information table 60 to change the allocation of the copy complete area from the DRAM area to the SRAM area. After update, the access from the MP 208 to the area having been copied is executed to the SRAM.

### Data Copying Process

The actual process will be described with reference to FIG. 16. The process of FIG. 16 is started for example when the SM is expanded, a new PP is installed, or the microprogram is updated.

In S1601, the MP 208 divides the DRAM area within the SM address space shared and used by the DRAM and the SRAM into given sizes. For example, if the size of the DRAM area used in common is 1 MB, the MP 208 divides the 1 MB of DRAM area into 256 parts and forms small areas each having a capacity of 4 KB.

In S1602, the MP 208 selects one small area (4 KB).

In S1603, the MP 208 sets up a write access detection regarding the copy target small areas in the DRAM controller 2071.

In S1604, the MP 208 orders the memory controller to copy data from the selected small area of the DRAM to the SRAM area. The memory controller having received the order copies the data in the small area to the SRAM area, that is, copies the data of the DRAM 2072 to the SRAM 2074. The memory controller executes the copying operation corresponding to the data capacity of the small area (4 KB).

In S1605, the MP 208 determines based on the write access detection information from the DRAM controller 2071 whether a write access has occurred to the small area of the copy target DRAM area during the copying process.

When a write access has occurred (S1605: Yes), the MP 208 order the memory controller to copy data to the DRAM area in S1604, and re-executes the data copying process.

When a write access has not occurred (S1605: No), the MP 208 adds the copy complete area to the entry of the window resister information table 60 in S1606.

Actually, the MP 208 sets a leading address of the 4 KB worth of copy complete data to the entry of the start SM address 601 corresponding to the copy target area in the window resister information table 60, and sets up 4 KB of capacity in the entry of the size 602.

In S1607, it is determined whether copying of all areas of the copy target has been completed or not.

When copy is not completed (S1607: No), the MP 208 executes the processes of S1602 and thereafter.

When copy is completed (S1607: Yes), the MP 208 ends the data copying process from the DRAM to the SRAM while access to the CMPK is maintained.

According to the above process, it is possible to copy data from the DRAM 2072 to the SRAM 2074 while continuing access from the MP to the SM of the CMPK 202 and while maintaining the duplicated state of the SM. In FIGS. 15 and 16, the MP and the memory controller cooperate to execute the data copy operation, but it is also possible for the memory controller alone to execute the data copy operation based on the order from the MP.

As described, according to the present invention having a shared memory composed of a plurality of memories having different performances, it is not necessary to stop accesses to the SM in the CMPK 202 even when the data stored in a memory having a high access performance is collectively changed in response to the change of settings of the disk subsystem.

Further, it is possible to prevent a long-term access performance deterioration caused by determining the data to be stored in a memory having a high performance considering access frequencies and the like after installing program products such as a local copy function or a remote copy function and after starting operation of the system.

Even further, it is possible to change the settings of the SRAM area while maintaining operation of the disk subsystem by selecting data possibly having a high frequency of use via the local copy function and storing the data collectively into the high-speed SRAM area. Therefore, even when installing a specific PP and starting operation thereof, the access performance to data having a high frequency of use can be enhanced.

The shared memory in a duplicated state has been described in the above description, but the present invention can also be applied to a memory in a multiplexed state. The present description referred to DRAMs and SRAMs as examples of volatile memories, but the present invention can be applied to other types of volatile memories.

Furthermore, it is possible to use a nonvolatile memory such as a flash memory instead of a volatile memory. Moreover, the present invention can be applied to a combination of volatile memories and nonvolatile memories. The present invention has been applied to a disk subsystem, but the present invention can also be applied to other actual products, such as a server as an information processing device.

The present invention is not restricted to the embodiments mentioned above, and other various modified examples are included in the scope of the invention. The preferred embodiments of the present invention have been merely illustrated for better understanding of the present invention, and not necessarily all the components illustrated herein are required to realize the present invention.

A portion of the configuration of an embodiment can be replaced with the configuration of another embodiment, or the configuration of an embodiment can be added to the configuration of another embodiment. Moreover, all portions of the configurations of the respective embodiments can have other configurations added thereto, deleted therefrom, or replaced therewith.

Moreover, a portion or all of the configurations, functions, processing units, processing means and the like described in the description can be realized by hardware such as by designed integrated circuits. The respective configurations, functions and the like can also be realized by software such as by having a processor interpret the program for realizing the respective functions and through execution of the same.

The information such as the programs, tables, files and the like for realizing the respective functions can be stored in storage devices such as memories, hard disks and SSDs (Solid State Drives), or in storage media such as IC cards, SD cards and DVDs.

The control lines and information lines considered necessary for description are illustrated, and not all the control lines and information lines required for production are illustrated. Actually, it can be considered that almost all components are mutually connected.

### REFERENCE SIGNS LIST

20 Disk Subsystem
50 SRAM allocation area table
60 Window resister information table
202 CMPK
206 Routing unit
208 MP
2021 HIT determination circuit
2022 Window resister
2071 DRAM controller
2072 DRAM
2073 SRAM controller
2074 SRAM

1. A disk subsystem comprising:
a plurality of processors; and
a memory unit composed of a first memory and a second memory for storing data processed via the processor;
wherein the memory unit includes a first memory unit in which a first type of access from the plurality of processors is executed and a second memory unit in which a second type of access is executed;
when the processor detects change of configuration of the first memory or the second memory within the memory unit while maintaining the access from the processors to the memory unit, the processor is caused to:
change a configuration of the second memory unit based on a configuration information after change of configuration;
switch an access to the second memory unit to a first type;
switch an access to the first memory unit to a second type; and
change a configuration of the first memory unit based on a configuration information after the change of configuration.

2. The disk subsystem according to claim 1, wherein the change of configuration of the memory unit is any one of the following changes:
change of allocation or change of capacity of the second memory,
change of data type stored in the second memory, or change of program for controlling the whole disk subsystem.

3. The disk subsystem according to claim 1, wherein the first type of access is a read access and a write access, and the second type of access is a write access.

4. The disk subsystem according to claim 1, wherein the second memory has a higher speed than the first memory.

5. The disk subsystem according to claim 4, wherein the first memory is composed of a DRAM and the second memory is composed of a SRAM.

6. The disk subsystem according to claim 4, wherein the data having a high access frequency is stored in the second memory.

7. The disk subsystem according to claim 6, wherein based on the change of configuration of the first memory unit or the second memory unit, the data stored in the second memory prior to change of configuration is copied to the first memory, and the data stored in the first memory after change of configuration is copied to the second memory.

8. The disk subsystem according to claim 7, wherein the copy is performed per each divided area in which the first memory unit or the second memory unit are divided into two or more areas, and when write access to the area occurs while copying the divided area, the whole area is copied again.

9. The disk subsystem according to claim 7, wherein after changing the configuration, a data having a high access frequency is specified, and the specified data having a high access frequency is stored in the second memory unit.

10. The disk subsystem according to claim 1, wherein
the second memory is mapped to a logical address space accessed by the processor;
the system has an area allocation information of the logical address space to which the second memory is mapped;
a correspondence information of the logical address and a physical address of the second memory; and
the area allocation information and the corresponding information are compared to detect a change of setting.

11. The disk subsystem according to claim 10, wherein
the area allocation information is composed of an initial logical address information and a size information of the area, and an effective information for determining the effectiveness of the initial address information and the size information.

12. The disk subsystem according to claim 10, wherein
the correspondence information is composed of an initial logical address information and a size information of the area, and a physical address of the second memory.

13. A method for controlling memory access of a disk subsystem, wherein
a memory unit composed of a first memory and a second memory has a first memory unit in which a first type of access is executed and a second memory unit in which a second type of access is executed; and
when a change of configuration of the first memory or the second memory is detected while maintaining the access to the memory unit, the following processes are performed:
changing a configuration of the second memory unit;
switching an access to the second memory unit to the first type;
switching an access to the first memory unit to the second type; and
changing a configuration of the first memory unit.

14. The method for controlling memory access according to claim 13, wherein the change of configuration of the memory unit is any one of the following changes: change of allocation or change of capacity of the second memory, change of data type stored in the second memory, or change of program for controlling the whole disk subsystem.

15. The method for controlling memory access according to claim 13, wherein the first type of access is a read access and a write access, and the second type of access is a write access.
